(19) United States
(12) Patent Application Publication
(10) Pub. No.: US 2020/0342485 A1
(43) Pub. Date: Oct. 29, 2020

(54) SYSTEMS AND METHODS FOR PAYMENT NETWORK-BASED CASH BACK PROCESSING

(71) Applicant: MASTERCARD INTERNATIONAL INCORPORATED, Purchase, NY (US)

(72) Inventors: Issidor Iliev, White Plains, NY (US); Erick Andrew, New York, NY (US)

(21) Appl. No.: 16/395,965

(22) Filed: Apr. 26, 2019

(51) Int. Cl. G06Q 30/02; G06Q 30/04

(52) U.S. Cl. CPC G06Q 30/0215; G06Q 30/04

(57) ABSTRACT

A computer-implemented method for payment network-based cash back processing can include receiving, by processing circuitry, transaction information related to a cardholder transaction with a merchant. The processing circuitry can identify whether the transaction qualifies for a cash back offer selected from a set of one or more cash back offers. The processing circuitry can calculate a cash back amount associated with the merchant based on information contained in the merchant and offers database. The processing circuitry can calculate a cardholder billing amount, an issuer settlement amount, an acquirer settlement amount, a refund amount, and a program fee amount. The processing circuitry can generate a refund message including the refund amount to be processed to the cardholder and a fee message for fee collection. The processing circuitry can receive a program fee, receive an issuer settlement amount from an issuer, send the acquirer settlement amount to a merchant acquirer, and send the program fee amount to a third party.

### BACKGROUND

The disclosed subject matter relates to systems and methods for payment network-based cash back processing.

Traditional cash back portals generally provide referral links to online merchants, and allow consumers to navigate to merchant web sites from cash back portals, where the consumers will receive cash back on purchases subsequently made at those merchant web sites. The consumer receives cash back, usually in terms of percentage points of the total purchase value of goods purchased on the merchant web sites that are visited through the referral link of the online cash portal. In these arrangements, merchants generally provide the cash back through the cash back portal companies by transferring the cash back to the cash back portal companies for distribution to the consumers who made qualifying purchases. In addition, cash back portal companies generally have agreements with merchants, whereby merchants pay cash back portal companies a fee for referrals at some time after qualifying purchases are made. Furthermore, such previous systems rely on web-based purchases.

Accordingly, there exists a need for improved systems and methods for cash back processing, including payment network-based cash back processing systems and methods that efficiently process cash back for qualifying purchases made by consumers at merchants who have cash back offer agreements with cash back portal companies and/or other third parties.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a computer-implemented method for payment network-based cash back processing is disclosed. The method can include receiving, by processing circuitry, transaction information related to a cardholder transaction with a merchant The processing circuitry can identify whether the transaction qualifies for a cash back offer, which can be selected from a set of one or more cash back offers. The processing circuitry can calculate a cash back amount associated with the merchant based at least partly on information contained in the merchant and offers database. The processing circuitry can calculate a cardholder billing amount, an issuer settlement amount, an acquirer settlement amount, a refund amount, and a program fee amount. The processing circuitry can generate a refund message including the refund amount to be processed to the cardholder and a fee message for fee collection. The processing circuitry can receive a program fee, receive, from an issuer, the issuer settlement amount; send, by the processing circuitry, to a merchant acquirer, the acquirer settlement amount; and send, to a third party, the program fee amount.

For purpose of illustration and not limitation, the issuer settlement amount can be equal to a cardholder billing amount, less a refund amount.

For purpose of illustration and not limitation, the acquirer settlement amount can be equal to a cardholder billing amount, less the refund amount and the program fee amount.

For purpose of illustration and not limitation, the processing circuitry can automatically send at least a portion of the program fee to a cash back portal company.

For purpose of illustration and not limitation, the cash back account number database and the merchant and offers database can be maintained on a payment network server.

For purpose of illustration and not limitation, the processing circuitry can identify whether the transaction qualifies for a cash back offer by identifying whether a cardholder account number is included in a cash back account number database and whether the merchant is listed in a merchant and offers database.

For purpose of illustration and not limitation, the cardholder transaction can be one of an online transaction or an in-store transaction.

For purpose of illustration and not limitation, the processing circuitry can identify whether the transaction qualifies for a cash back offer based at least partly on one or more of a merchant code associated with the merchant, a time of day of the transaction, a day of the week of the transaction, a calendar date of the transaction, a number of transactions the cardholder has performed at the merchant within a period of time, or a transaction amount.

For purpose of illustration and not limitation, the processing circuitry can identify whether the transaction qualifies for a cash back offer based at least partly on a payment card product code associated with the transaction. In accordance with another aspect of the disclosed subject matter, a system for payment network-based cash back processing is disclosed. The system can include at least one memory storing computer program code and at least one processor, wherein the computer program code is configured, when executed by the at least one processor, to cause the system to receive transaction information related to a cardholder transaction with a merchant. The system can be configured to identify whether the transaction qualifies for a cash back offer, selected from one or more cash back offers. The system can be configured to calculate a cash back amount associated with the merchant based at least partly on information contained in the merchant and offers database. The system can be configured to calculate a cardholder billing amount, an issuer settlement amount, an acquirer settlement amount, a refund amount, and a program fee amount. The system can be configured to generate a refund message including the refund amount to be processed to the cardholder. The system can be configured to generate a fee message for fee collection and receive a program fee. The system can be configured to receive, from an issuer, the issuer settlement amount; send, by the processing circuitry, to a merchant acquirer, the acquirer settlement amount; and send, to a third party, the program fee amount.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative payment network according to an illustrative embodiment of the disclosed subject matter.

FIG. 2 is a diagram illustrating a system for payment network-based cash back processing according to an illustrative embodiment of the disclosed subject matter.

FIG. 3 is a flow chart illustrating a representative method for sourcing offers that can be processed using payment network-based cash back processing, implemented according to an illustrative embodiment of the disclosed subject matter.

FIG. 4 is a flow chart illustrating a representative method for payment network-based cash back processing, implemented according to an illustrative embodiment of the disclosed subject matter.

FIG. 5 is a block diagram illustrating further details of a representative computer system according to an illustrative embodiment of the disclosed subject matter.

Throughout the drawings, the same reference numerals and characters, unless otherwise stated, are used to denote like features, elements, components or portions of the illustrated embodiments. Moreover, while the present disclosed subject matter will now be described in detail with reference to the figures, it is done so in connection with the illustrative embodiments.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods and systems presented herein can be used for payment network-based cash back processing of in-store and/or online cash back transactions.

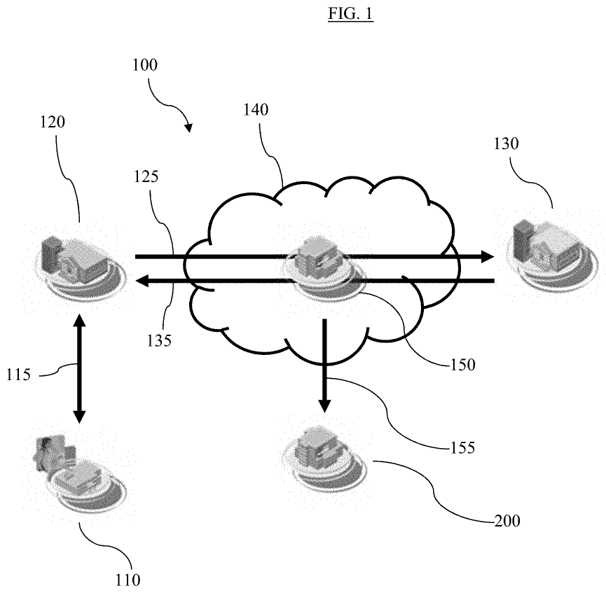

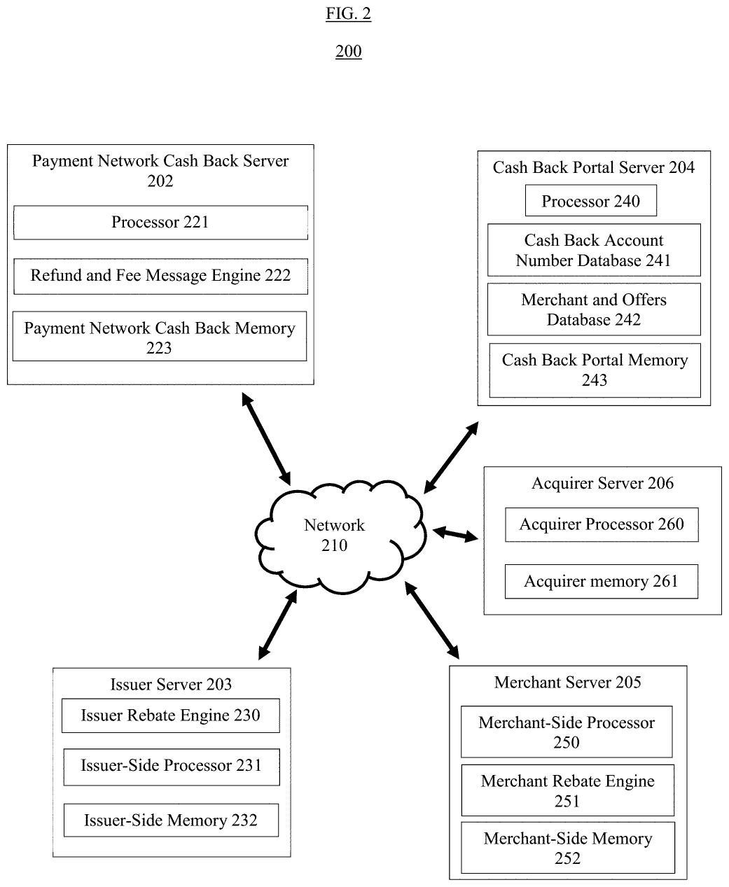

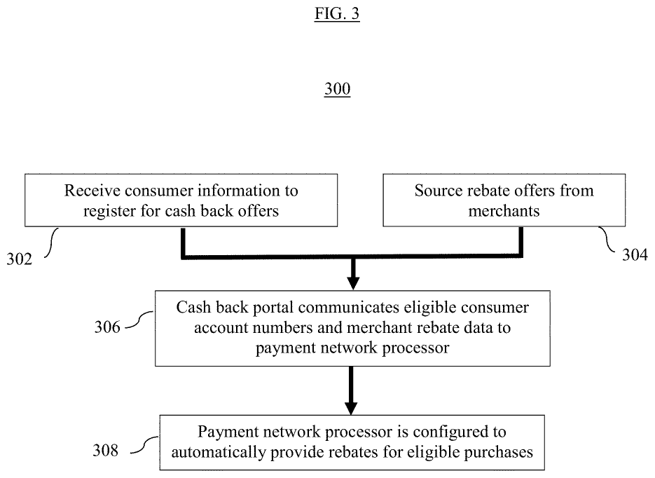

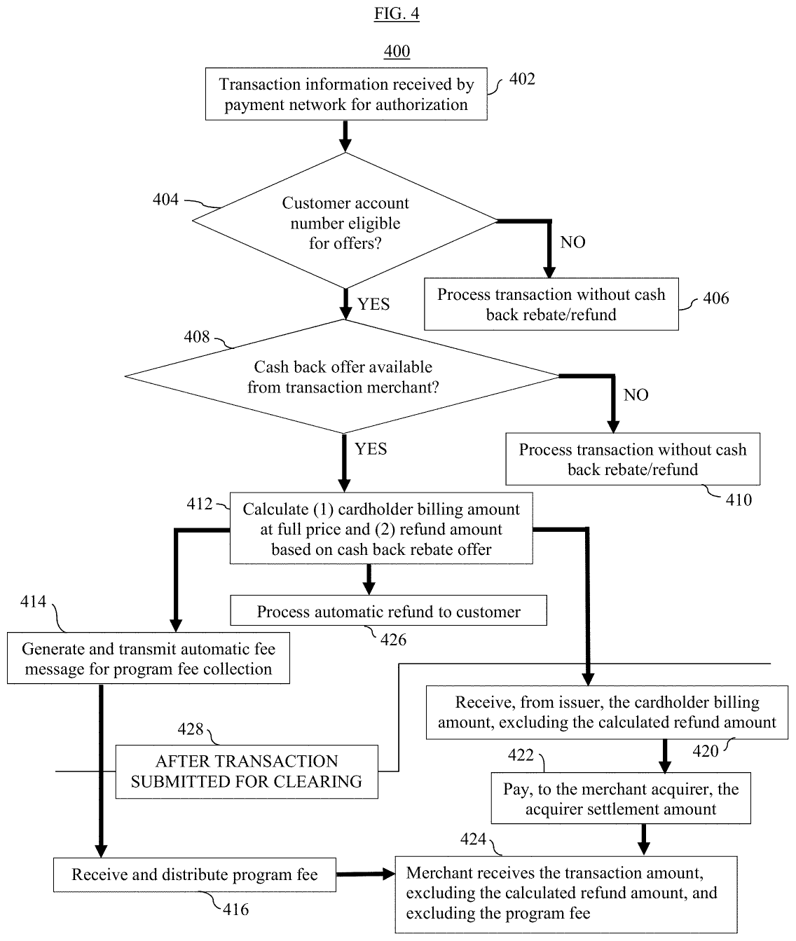

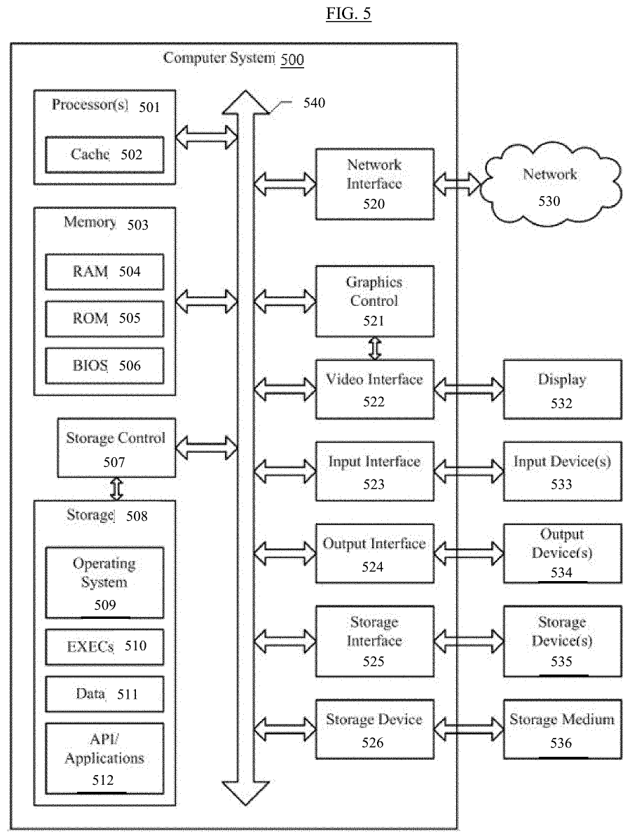

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, an exemplary embodiment of a payment network for payment network-based cash back processing in accordance with the disclosed subject matter is shown in FIG. 1. FIG. 2 is a diagram illustrating a system for payment network-based cash back processing according to an illustrative embodiment of the disclosed subject matter. FIG. 3 is a flow chart illustrating a representative method for sourcing offers that can be processed using payment network-based cash back processing, implemented according to an illustrative embodiment of the disclosed subject matter. FIG. 4 is a flow chart illustrating a representative method for payment network-based cash back processing, implemented according to an illustrative embodiment of the disclosed subject matter. A block diagram illustrating further details of a representative computer system according to an illustrative embodiment of the disclosed subject matter is shown in FIG. 5.

While the present disclosed subject matter is described with respect to using methods and systems for in-store cash back processing, one skilled in the art will recognize that the disclosed subject matter is not limited to the illustrative embodiments. For example, the disclosed methods and systems for in-store cash back processing can be used with a wide variety of settings, such as online merchant transactions, promoting merchant and issuer services, payment card products, benefits, and loyalty programs, and a variety of other applications.

FIG. 1 depicts a diagram illustrating a representative payment network 100 according to an illustrative embodiment of the disclosed subject matter. Payment network 100 can allow for payment transactions in which merchants and card issuers do not necessarily have a one-to-one relationship. The payment network 100, for example and without limitation a credit card payment system, can utilize an electronic payment network 140, such as the Mastercard® payment card system interchange network. Mastercard® payment card system interchange network is a proprietary communications standard promulgated by Mastercard International Incorporated® based on the ISO 8583 message format for the exchange of financial transaction data between financial institutions that are customers of Mastercard International Incorporated. (Mastercard is a registered trademark of MasterCard International Incorporated located in Purchase, N.Y.)

As embodied herein, the payment network 100 can include at least one merchant 110 connected to at least one electronic payment network 140, either directly or through an acquirer 120 via connection 115. At least one acquirer 120 can be connected to the electronic network 140, and each merchant 110 can be in communication with at least one acquirer 120 via the at least one payment network 140 or connection 115. At least one issuer 130 can be connected to the electronic network 140, and each acquirer 120 can be in communication with at least one issuer 130 via the electronic payment network 140.

For purpose of illustration and not limitation, in payment network 100, a financial institution, such as an issuer 130, can issue an account, such as a credit card account or a debit card account, to a cardholder (e.g., an individual consumer or a corporate or commercial customer), who can use the payment account card to tender payment for a purchase from a merchant 110 or to conduct a transaction at an ATM or website. To accept payment with the payment account card, merchant 110 can establish an account with a financial institution that is part of the financial payment system. This financial institution can be referred to as the “merchant bank” or the “acquiring bank,” or herein as “acquirer 120.” When a cardholder tenders payment for a purchase with a payment account card, the merchant, ATM, or website 110 can request authorization from acquirer 120 for the amount of the purchase. The request can be performed over the telephone, online via a website, or through the use of a point-of-sale terminal which can read the cardholder's account information from the magnetic stripe on the payment account card, from a smart card using contact pads, or contactlessly from a near-field communication (NFC) device and communicate electronically with the transaction processing computers of acquirer 120. Alternatively, acquirer 120 can authorize a third party to perform transaction processing on its behalf. In this case, the point-of-sale terminal can be configured to communicate with the third party. Such a third party can be referred to as a “merchant processor” or an “acquiring processor.”

As embodied herein, using payment network 100, the computers of acquirer 120 or the merchant processor can communicate information regarding payment card transactions with computers of the issuer 130. For example and not limitation, information regarding payment card transactions can include an authorization request 125 and an authorization response 135. An authorization request 125 can be communicated from the computers of the acquirer 120 to the computers of issuer 130 to determine whether the cardholder's account is in good standing and whether the purchase is covered by the cardholder's available credit line or account balance. Based on these determinations, the authorization request 125 can be declined or accepted, and an authorization response 135 can be transmitted from the issuer 130 to the acquirer 120, and then to the merchant, ATM, or website 110. The authorization request 125 can include account information identifying the merchant, location information (e.g., an address of the merchant), and transaction information, as discussed herein. The authorization response 135 can include, among other things, a result of the determination that the transaction is approved or declined and/or information about the status of the payment card or payment account.

For example and not limitation, at least one payment network server 150 can be connected to the electronic payment network 140 and configured to automatically capture the data representing a plurality of variables related to payment card transactions from the electronic payment network 140. Additionally, the payment network server can be connected to a system 200 for in-store cash back processing either by the electronic payment network 140 or a separate connection 155. As embodied herein, the payment network server 150 can be configured to only capture the data representing a plurality of variables related to payment card transactions with the permission of the cardholder. Additionally, the payment network server 150 can be configured to only capture the information regarding payment card transactions in accordance with applicable data privacy laws.

FIG. 2 depicts a block diagram illustrating a representative system 200 for in-store cash back processing according to an illustrative embodiment of the disclosed subject matter. The exemplary system 200 can include a payment network cash back server 202, a cash back portal server 204, an issuer server 203, merchant server 205, and acquirer server 206, which can all communicate with each other over network 210. Network 210 may be a wireless network, local area network, the world wide web, or any other suitable network. As an example of an advantage of the disclosed subject matter, the disclosed configurations can process cash back offers as part of the process of authorization, clearing and settlement of a payment transaction with the merchant, thereby simplifying the process of providing cash back offers to customers, which previously relied on processing cash back as one or multiple manual transactions between multiple disjointed parties. In addition, or alternatively, the disclosed subject matter can provide processing of cash back offers whether the transactions take place in-store or online.

In some embodiments, the cash back portal server 204 can be included in payment network cash back server 202. For example, the processor 240 and processor 221 can be part of the same processor and/or can share processing circuitry and/or processing software. In some embodiments, the payment network cash back server 202 and cash back portal server can be independent entities that do not share the same resources, are independently managed, and/or can be located on different servers and/or in different locations.

In some embodiments, payment network cash back server 202 can include rebate engine 220, processor 221, refund and fee message engine 222, and payment network cash back memory 223. Refund and fee message engine 222 can operate to create automatic messages containing refund and fee amounts, for transmission to issuer, acquirer, cash back portal, and/or merchant servers, using processor 221 and payment network cash back memory 223.

In some embodiments, cash back portal server 204 can include processor 240, cash back account number database 241, merchant and offers database 242, and cash back portal memory 243. Cash back account number database 241 can store account numbers of cardholders who have registered for one or more offers, which correspond to agreements between one or more merchants and one or more of a cash back portal company, payment company, or a bank. Merchant and offers database 242 can store information related to one or more merchants and one or more corresponding offers that are available for access or subscription by cardholders. For example, a merchant could offer 1% cash back on all goods purchased by cardholders subscribing to the offer. In such an example, the cash back offer can be merchant-funded. In some embodiments, cash back offers can be funded by a variety of means, including being funded by the operator of a payment network, an issuer, or some combination of these, or other, entities. The cash back portal server 204 can operate using cash back portal memory 243. Cash back account number database 241 can include account numbers for consumers who have signed up to receive one or more offers for in-store cash back offers, online cash back offers, or both in- store and online cash back offers, at various merchants In some embodiments, the cash back account number database 241 and the merchant and offers database 242 can comprise a single database containing both account numbers and merchant offers.

In some embodiments, issuer server 203 can include issuer rebate engine 230, issuer-side processor 231, and issuer-side memory 232. Issuer rebate engine 230 can receive and send information related to automatic refunds received by cardholders through cash back offers, and can operate using issuer-side processor 231 and issuer-side memory 232.

In some embodiments, merchant server 205 can include merchant-side processor 250, merchant rebate engine 251, and merchant-side memory 252. The merchant server 205 can process information and send and receive communications to and from acquirer server 206, cash back portal server 204, and payment network server 202, using merchant-side processor 250, Merchant rebate engine 251, and Merchant-side memory 252.

In some embodiments, acquirer server 206 can include acquirer processor 260 and acquirer memory 261, which can operate to process, receive, and send communications to and from merchant server 205, cash back portal server 204, and payment network cash back server 202.

FIG. 3 is a flow chart illustrating a representative method 300 for sourcing offers that can be processed using payment network-based cash back processing, implemented according to an illustrative embodiment of the disclosed subject matter.

As embodied herein, at 302, the cash back portal server 204 can receive information from a consumer to register the consumer for cash back offers. In some embodiments, the information can comprise cardholder account number information of the consumer. In some embodiments, consumer information can include other identifying details such as name, address, birth date, information related to payment card products held by the consumer, and information related to spending habits of the consumer. In some embodiments, consumer information can be received by the cash back portal server 204 for storage in the cash back account number database 241. In some embodiments, consumer information can be received by the payment network cash back server 202, for storage in the cash back account number database 241. If the cash back account number database 241 is a part of the cash back portal server 204, the consumer information can be received over a network 210. In some embodiments, cash back account number database 241 can be a part of the payment network cash back server 202.

At 304, rebate offers can be sourced from merchants by, for example, cash back portal companies through the cash back portal server 204, or by payment network operators through the payment network cash back server 202. In some embodiments, one or more cash back portal companies can source rebate offers from merchants For example, a hardware store might agree to offer a 1.5% rebate to all customers who sign up for the rebate through the cash back portal. The cash back portal company can therefore provide advertising and marketing for the hardware store in exchange for a program fee associated with the rebate. In this example, the program fee is paid by the merchant, and the merchant funds the rebate. In some embodiments, payment network operators and/or acquirers can source cash back offers from merchants in a similar manner, and can receive some or all of a program fee associated with rebates.

At 306, the cash back portal server 204 can communicate eligible consumer account numbers and merchant rebate data to a payment network cash back server 202. Payment network cash back server 202 can be configured to automatically detect transactions that qualify for cash back offers. In some embodiments, cash back account number database 241 and merchant and offers database 242 are part of payment network cash back server 202.

At 308, the payment network cash back processor 221 can be configured to automatically provide rebates for eligible purchases. Such a configuration can be achieved through programming that configures processor 221 to compare transaction information, including cardholder account number, payment card product code, merchant code, or other transaction information, with cardholder account numbers and merchant offers and rebates stored in the cash back account number database 241 and the merchant and offers database 242 respectively.

FIG. 4 is a flow chart illustrating a representative method 400 for payment network-based cash back processing, implemented according to an illustrative embodiment of the disclosed subject matter.

As embodied herein, at 402, transaction information can be received by a payment network for authorization. For example, the transaction can be an in-store transaction or an online transaction through a merchant website. In some embodiments, the transaction information can be received by system 200, at the payment network cash back server 202. At 404, payment network cash back server 202 can identify whether the cardholder qualifies for one or more cash back offers. For example, payment network cash back server 202 can, through processor 221, reference the cash back account number database 241, and thereby determine if the cardholder, through an account number associated with the transaction, is eligible for one or more cash back offers. If the cardholder is not eligible for any cash back offers, the payment network can continue to authorize, clear and settle the transaction without an automatic rebate, at 406. If the cardholder is registered for one or more cash back offers, the payment network cash back server 202 can determine whether the transaction at issue is eligible for cash back. In some embodiments, the cardholder does not need to register for one or more cash back offer. For example, and not by way of limitation, one or more offers can be available to all cardholders using a payment card product operated using the payment network. For example, all cardholders can be automatically eligible for a cash back offer for shopping at a hardware store on Memorial Day.

At 408, payment network cash back server 202 can identify whether one or more cash back offers for which the customer qualifies, is available based on the transaction merchant. For example, payment network cash back server 202 can, through processor 221, reference the merchant and offers database 242, and thereby determine if the cardholder, through an account number associated with the transaction, is eligible for one or more cash back offers that is offered by the merchant. If not, the payment network can continue to authorize, clear and settle the transaction without an automatic rebate, at 410. If the cardholder is registered for one or more cash back offers through this merchant transaction, the payment network cash back server 202 can determine whether the particular transaction at issue is eligible for cash back.

In some embodiments, cash back offers can be available from a merchant based on one or more payment card product codes associated with a transaction. For example, and certainly not by way of limitation, a cardholder could be eligible for cash back on purchases made using one or more certain payment cards associated with an issuer or associated with the payment network. For example, and certainly not by way of limitation, customers of a merchant who use a credit card issued by a certain bank or who use a credit card of a certain type and/or a credit card associated with a certain payment network can be eligible for cash back from the merchant by virtue of the payment card product that is used to conduct transactions with the merchant

In some embodiments, cash back offers can be available based on the time of day, the day of the week, or the calendar date on which the transaction is initiated. For example, and not by way of limitation, there may be different levels of cash back offered for a transaction at one or more restaurants occurring between 11:00 AM and 2:00 PM, or after 6:00 PM (such as to provide a “lunch discount” or “dinner discount”). In some embodiments, payment network cash back server 202 can reference a database that contains cash back eligibility information related to one or more criteria, such as cash back offers that are available based on the time of day, day of the week, or calendar date of a transaction, and payment network cash back server 202 can reference a database containing cash back offers that are offered by one or more merchants. For example, and not by way of limitation, one or more of payment network cash back memory 223, cash back account number database 241, merchant and offers database 242, and/or cash back portal memory 243 can contain such databases.

In some embodiments, payment network cash back server 202 can identify whether a transaction qualifies for one or more cash back offers based on the number of transactions the consumer has performed at the merchant within a certain time frame. For example, and not by way of limitation, a transaction may qualify for cash back if the consumer has conducted a certain number of transactions at the same merchant within a predetermined time period. For example, and not by way of limitation, a cardholder that conducts nine transactions at a merchant within one week could qualify to receive cash back on the tenth transaction in the same week. For example, and not by way of limitation, payment network cash back server 202 can count each transaction performed for a given account number, or by a certain cardholder by one or more other identifiers, and with reference to one or more databases containing one or more rules establishing cash back offers based on a number of transactions within one or more periods of time at one or more merchants, can determine whether a given cardholder transaction qualifies for one or more cash back offers. For example, and not by way of limitation, one or more of payment network cash back memory 223, cash back account number database 241, merchant and offers database 242, and/or cash back portal memory 243 can contain such databases.

In some embodiments, payment network cash back server 202 can identify whether a transaction qualifies for cash back based on the size of the transaction amount. For example, and certainly not by way of limitation, transactions over one hundred dollars can automatically be eligible for one or more cash back offers.

In some embodiments, payment network cash back server 202 can count how many times a cash back offer is used, and can limit the use of certain cash back offers to a limited number of uses. For example, and not by way of limitation, a cardholder might qualify for a cash back offer when purchasing a salad from one or more local merchants, but if the cardholder purchases a second salad within a certain period of time, or at any time after the first purchase, such second purchase can be identified as taking place after a qualifying purchase and payment network cash back server 202 can identify that a cash back offer should not be applied.

At 412, the payment network cash back server 202 can calculate a cardholder billing amount at the full price of the transaction and a refund amount to be automatically refunded to the cardholder based on one or more cash back offers. Such calculations can be carried out by processor 221.

At 420, after clearing of the transaction 428, the payment network cash back server 202 can receive, from issuer server 203, an amount of currency equal to the transaction amount, less the calculated refund amount. Issuer server 203 can complete that transaction using issuer rebate engine 230 and issuer-side processor 231, which can receive and send communications to the payment network cash back server 202, for example using network 210.

At 422, the payment network cash back server 202 can pay, to the acquirer, the transaction amount, less the calculated refund amount. In some embodiments, the transaction amount can be sent to the acquirer server 206, which can operate an acquirer processor 260 and memory 261 to receive and send data to/from payment networks and merchants. In some embodiments, an acquirer settlement amount sent to the merchant acquirer can be equal to the transaction amount, less the calculated refund amount, and less a program fee amount.

At 414, the payment network cash back server 202 can generate and transmit an automatic fee message for program fee collection. In some embodiments, the program fee message can be sent to the acquirer server 206 and/or to the merchant server 205, to request payment of a program fee associated with processing cash back offers.

At 416, after clearing of the transaction 428, the payment network cash back server 202 can receive and distribute the program fee. For example, and certainly not by way of limitation, the program fee can be received from the merchant or acquirer server, and the payment network cash back server 202 can automatically allocate a portion for transmission to the cash back portal server 204 to allocate a share of the program fee to the cash back portal company, if the cash back offer is provided through a cash back portal company. In some embodiments, such transmission of a portion of the program fee can be performed in aggregate, to transmit the program fee for more than one transaction. For example, and certainly not by way of limitation, such a transmission of a portion of program fees can take place on a regular schedule, such as once per day, once per week, or once per month. In some embodiments, the program fee is expressed as a percentage of the transaction value and/or can be calculated based on the cash back provided to the customer.

At 426, the payment network cash back server 202 can automatically process the refund to the customer. For example, and certainly not by way of limitation, payment network cash back server can initiate a refund transaction with issuer server 203, to refund the customer the cash back amount corresponding to the cash back offer for which the cardholder is eligible. In some embodiments, the refund amount returned to the cardholder is subtracted from the amount ultimately transmitted to the merchant Additionally, or alternatively, payment network cash back server 202 can be configured to check whether an authorized transaction is submitted for clearing, and to reverse the refund if the transaction was never submitted for clearing. Additionally, or alternatively, payment network cash back server can send a refund message to a third party for processing of the refund to the customer. Additionally, or alternatively, payment network cash back server can send a refund message to a third party and can then await instructions for processing of the refund to the customer.

At 424, the merchant receives the transaction amount, excluding the calculated refund amount and excluding any program fee paid by the merchant. In some embodiments, such amount can be received at the acquirer server 206 from the payment network cash back server 202. In some embodiments, payment network cash back server 202 can automatically generate one or more reports to provide information related to the transaction amount, refund amount, and/or settlement amounts to one or more of the merchant, issuer, acquirer, or cardholder.

In some embodiments, the process of sending the transaction amount to the merchant can involve multi-party settlement functionality. For example, and certainly not by way of limitation, multi-party settlement can be used to settle the revenue sharing generated by the arrangement between the payment network provider and a cash back portal company in an efficient way. For example, during the clearing process, the payment network cash back server 202 can calculate and execute the cash back rebate amount to the cardholder, the settlement amount to the merchant acquirer, the settlement amount to the issuer of the cardholder, and a settlement amount to the acquirer of a cash back portal company for the program fee.

FIG. 5 is a block diagram illustrating further details of a representative computer system according to an illustrative embodiment of the disclosed subject matter.

The systems and techniques discussed herein can be implemented in a computer system. As an example and not by limitation, as shown in FIG. 5, the computer system having architecture 500 can provide functionality as a result of processor(s) 501 executing software embodied in one or more tangible, non-transitory computer-readable media, such as memory 503. The software implementing various embodiments of the present disclosure can be stored in memory 503 and executed by processor(s) 501. A computer-readable medium can include one or more memory devices, according to particular needs. Memory 503 can read the software from one or more other computer-readable media, such as mass storage device(s) 535 or from one or more other sources via communication interface 520. The software can cause processor(s) 501 to execute particular processes or particular parts of particular processes described herein, including defining data structures stored in memory 503 and modifying such data structures according to the processes defined by the software. An exemplary input device 533 can be, for example, a keyboard, a pointing device (e.g., a mouse), a touchscreen display, a microphone and voice control interface, a pressure sensor or the like to capture user input coupled to the input interface 523 to provide data and/or user input to the processor 501. An exemplary output device 534 can be, for example, a display (e.g., a monitor) or speakers or a haptic device coupled to the output interface 524 to allow the processor 501 to present a user interface, visual content, and/or audio content. Additionally or alternatively, the computer system 500 can provide an indication to the user by sending text or graphical data to a display 532 coupled to a video interface 522. Furthermore, any of the above components can provide data to or receive data from the processor 501 via a computer network 530 coupled the communication interface 520 of the computer system 500. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 501 includes hardware for executing instructions, such as those making up a computer program. As an example and not by way of limitation, to execute instructions, processor 501 can retrieve (or fetch) the instructions from an internal register, an internal cache 502, memory 503, or storage 508; decode and execute them; and then write one or more results to an internal register, an internal cache 502, memory 503, or storage 508. In particular embodiments, processor 501 can include one or more internal caches 502 for data, instructions, or addresses. This disclosure contemplates processor 501 including any suitable number of any suitable internal caches, where appropriate. As an example and not by way of limitation, processor 501 can include one or more instruction caches 502, one or more data caches 502, and one or more translation lookaside buffers (TLBs). Instructions in the instruction caches 502 can be copies of instructions in memory 503 or storage 508, and the instruction caches 502 can speed up retrieval of those instructions by processor 501. Data in the data caches 502 can be copies of data in memory 503 or storage 508 for instructions executing at processor 501 to operate on; the results of previous instructions executed at processor 501 for access by subsequent instructions executing at processor 501 or for writing to memory 503 or storage 508; or other suitable data. The data caches 502 can speed up read or write operations by processor 501. The TLBs can speed up virtual-address translation for processor 501. In some embodiments, processor 501 can include one or more internal registers for data, instructions, or addresses. This disclosure contemplates processor 501 including any suitable number of any suitable internal registers, where appropriate. Where appropriate, processor 501 can include one or more arithmetic logic units (ALUs); be a multi-core processor; or include one or more processors 501. Although this disclosure describes and illustrates a particular processor, this disclosure contemplates any suitable processor.

In some embodiments, memory 503 includes main memory for storing instructions for processor 501 to execute or data for processor 501 to operate on. As an example and not by way of limitation, computer system 500 can load instructions from storage 508 or another source (such as, for example, another computer system 500) to memory 503. Processor 501 can then load the instructions from memory 503 to an internal register or internal cache 502. To execute the instructions, processor 501 can retrieve the instructions from the internal register or internal cache 502 and decode them. During or after execution of the instructions, processor 501 can write one or more results (which can be intermediate or final results) to the internal register or internal cache 502. Processor 501 can then write one or more of those results to memory 503. In some embodiments, processor 501 executes only instructions in one or more internal registers or internal caches 502 or in memory 503 (as opposed to storage 508 or elsewhere) and operates only on data in one or more internal registers or internal caches or in memory 503 (as opposed to storage 508 or elsewhere). One or more memory buses (which can each include an address bus and a data bus) can couple processor 501 to memory 503. Bus 540 can include one or more memory buses, as described below. In particular embodiments, one or more memory management units (MMUs) reside between processor 501 and memory 503 and facilitate accesses to memory 503 requested by processor 501. In some embodiments, memory 503 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 503 can include one or more memories 504, where appropriate. Although this disclosure describes and illustrates particular memory, this disclosure contemplates any suitable memory.

In some embodiments, storage 508 includes mass storage for data or instructions. As an example and not by way of limitation, storage 508 can include a hard disk drive (HDD), a floppy disk drive, flash memory, an optical disc, a magneto-optical disc, magnetic tape, or a Universal Serial Bus (USB) drive or a combination of two or more of these. Storage 508 can include removable or non-removable (or fixed) media, where appropriate. Storage 508 can be internal or external to computer system 500, where appropriate. In some embodiments, storage 508 is non-volatile, solid-state memory. In some embodiments, storage 508 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 508 taking any suitable physical form. Storage 508 can include one or more storage control units facilitating communication between processor 501 and storage 508, where appropriate. Where appropriate, storage 508 can include one or more storages 508. Although this disclosure describes and illustrates particular storage, this disclosure contemplates any suitable storage.

In some embodiments, input interface 523 and output interface 524 can include hardware, software, or both, providing one or more interfaces for communication between computer system 500 and one or more input device(s) 533 and/or output device(s) 534. Computer system 500 can include one or more of these input device(s) 533 and/or output device(s) 534, where appropriate. One or more of these input device(s) 533 and/or output device(s) 534 can enable communication between a person and computer system 500. As an example and not by way of limitation, an input device 533 and/or output device 534 can include a keyboard, keypad, microphone, monitor, mouse, printer, scanner, speaker, still camera, stylus, tablet, touch screen, trackball, video camera, another suitable input device 533 and/or output device 534 or a combination of two or more of these. An input device 533 and/or output device 534 can include one or more sensors. This disclosure contemplates any suitable input device(s) 533 and/or output device(s) 534 and any suitable input interface 523 and output interface 524 for them. Where appropriate, input interface 523 and output interface 524 can include one or more device or software drivers enabling processor 501 to drive one or more of these input device(s) 533 and/or output device(s) 534. Input interface 523 and output interface 524 can include one or more input interfaces 523 or output interfaces 524, where appropriate. Although this disclosure describes and illustrates a particular input interface 523 and output interface 524, this disclosure contemplates any suitable input interface 523 and output interface 524.

As embodied herein, communication interface 520 can include hardware, software, or both providing one or more interfaces for communication (such as, for example, packet-based communication) between computer system 500 and one or more other computer systems 500 or one or more networks. As an example and not by way of limitation, communication interface 520 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 520 for it. As an example and not by way of limitation, computer system 500 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 500 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 can include any suitable communication interface 520 for any of these networks, where appropriate. Communication interface 520 can include one or more communication interfaces 520, where appropriate. Although this disclosure describes and illustrates a particular communication interface, this disclosure contemplates any suitable communication interface.

In some embodiments, bus 540 includes hardware, software, or both coupling components of computer system 500 to each other. As an example and not by way of limitation, bus 540 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 540 can include one or more buses 540, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A computer-implemented method for payment network-based cash back processing comprising:
receiving, by processing circuitry, transaction information related to a cardholder transaction with a merchant;
identifying, by the processing circuitry, whether the transaction qualifies for a cash back offer, selected from one or more cash back offers;
calculating, by the processing circuitry, a cash back amount associated with the merchant based at least partly on information contained in the merchant and offers database;
calculating, by the processing circuitry, a cardholder billing amount, an issuer settlement amount, an acquirer settlement amount, a refund amount, and a program fee amount;
generating, by the processing circuitry, a refund message including the refund amount to be processed to the cardholder;
generating, by the processing circuitry, a fee message for fee collection;
receiving, by the processing circuitry, a program fee; and
receiving, by the processing circuitry, from an issuer, the issuer settlement amount;
sending, by the processing circuitry, to a merchant acquirer, the acquirer settlement amount; and
sending, by the processing circuitry, to a third party, the program fee amount.

2. The method of claim 1, wherein the issuer settlement amount is equal to a cardholder billing amount, less a refund amount.

3. The method of claim 1, wherein the acquirer settlement amount is equal to a cardholder billing amount, less the refund amount and the program fee amount.

4. The method of claim 1, further comprising:
automatically sending, by the processing circuitry, at least a portion of the program fee to a cash back portal company.

5. The method of claim 1, wherein the cash back account number database and the merchant and offers database are maintained on a payment network server.

6. The method of claim 1, wherein identifying whether the transaction qualifies for a cash back offer comprises identifying whether a cardholder account number is included in a cash back account number database and whether the merchant is listed in a merchant and offers database.

7. The method of claim 1, wherein the cardholder transaction is one of an online transaction or an in-store transaction.

8. The method of claim 7, wherein the cardholder transaction is an in-store transaction.

9. The method of claim 1, wherein identifying whether the transaction qualifies for a cash back offer, is based at least partly on one or more of a merchant code associated with the merchant, a time of day of the transaction, a day of the week of the transaction, a calendar date of the transaction, a number of transactions the cardholder has performed at the merchant within a period of time, or a transaction amount.

10. The method of claim 1, wherein identifying whether the transaction qualifies for a cash back offer, is based at least partly on a payment card product code associated with the transaction.

11. A system for payment network-based cash back processing, comprising:
at least one memory storing computer program code; and
at least one processor;
wherein the computer program code is configured, when executed by the at least one processor, to cause the system to:
receive, by processing circuitry, transaction information related to a cardholder transaction with a merchant;
identify, by the processing circuitry, whether the transaction qualifies for a cash back offer, selected from one or more cash back offers;
calculate, by the processing circuitry, a cash back amount associated with the merchant based at least partly on information contained in the merchant and offers database;
calculate, by the processing circuitry, a cardholder billing amount, an issuer settlement amount, an acquirer settlement amount, a refund amount, and a program fee amount;
generate, by the processing circuitry, a refund message including the refund amount to be processed to the cardholder;
generate, by the processing circuitry, a fee message for fee collection;
receive, by the processing circuitry, a program fee;
receive, by the processing circuitry, from an issuer, the issuer settlement amount;
send, by the processing circuitry, to a merchant acquirer, the acquirer settlement amount; and
send, by the processing circuitry, to a third party, the program fee amount.

12. The system of claim 11, wherein the issuer settlement amount is equal to a cardholder billing amount, less a refund amount.

13. The system of claim 11, wherein the acquirer settlement amount is equal to a transaction amount, less the refund amount and the program fee amount.

14. The system of claim 11, further configured to:
automatically send, by the processing circuitry, at least a portion of the program fee to a cash back portal company.

15. The system of claim 11, wherein the cash back account number database and the merchant and offers database are maintained on a payment network server.

16. The system of claim 11, further configured to identify whether the transaction qualifies for a cash back offer by identifying whether a cardholder account number is included in a cash back account number database and whether the merchant is listed in a merchant and offers database.

17. The system of claim 11, wherein the cardholder transaction is one of an online transaction or an in-store transaction.

18. The system of claim 17, wherein the cardholder transaction is an in-store transaction.

19. The system of claim 11, further configured to identify whether the transaction qualifies for a cash back offer based at least partly on one or more of a merchant code associated with the merchant, a time of day of the transaction, a day of the week of the transaction, a calendar date of the transaction, a number of transactions the cardholder has performed at the merchant within a period of time, or a transaction amount.

20. The system of claim 11, further configured to identify whether the transaction qualifies for a cash back offer based at least partly on a payment card product code associated with the transaction.
